(19) United States
(12) Patent Application Publication
(10) Pub. No.: US 2021/0019276 A1
(43) Pub. Date: Jan. 21, 2021

(54) LINK SELECTION PROTOCOL IN A REPLICATION SETUP

(71) Applicant: EMC IP Holding Company LLC, Hopkinton, MA (US)

(72) Inventors: David Meiri, Somerville, MA (US); Anton Kucherov, Dudley, MA (US)

(73) Assignee: EMC IP Holding Company LLC, Hopkinton, MA (US)

(21) Appl. No.: 16/516,677

(22) Filed: Jul. 19, 2019

(51) Int. Cl. G06F 13/42; G06F 13/16; G06F 3/06

(52) U.S. Cl. CPC G06F 13/42; G06F 13/1668; G06F 3/0673; G06F 3/065; G06F 3/0613

(57) ABSTRACT

In one aspect, implementing a link selection protocol in a replication setup includes sending, by a control module to a selected routing module of a plurality of routing modules, an IO request and IO requirements to process the request. The IO requirements include an amount of data subject to the replication IO request and a latency requirement subject to the replication IO request. A further aspect includes comparing, by the selected routing module, the IO requirements to link status information of each of a plurality of links; selecting, by the selected routing module, one of the links assigned to the selected routing module as a function of the IO requirements and the link status information; and executing the IO request over the selected one of the links.

### BACKGROUND

In a storage system with multiple CPUs running native data replication code, for example, control modules in a content-addressable storage architecture (such as XtremIO from EMC DELL of Hopkinton, Mass.), there are also multiple transmit modules (e,g., routing modules), each with multiple links to a destination storage array. Each replication input/output (IO) needs to be transmitted by one of the routing modules through one of the links. One challenge is that while control modules need to select which link to use, only the routing modules have the information on the current state of the various links.

For example, a routing module might have three links, one with high latency, one with low latency but a large queue of pending requests, and a third with no requests at all and a medium latency. The difference in link throughput/latency can be a result of different media for the link, the amount of work already sent to the link, link issues, or load on the target. This information can change constantly. Thus, it is impractical to update all control modules with the current link state at all times and, therefore, control modules may be unable to make an informed decision on which link to choose. Further, it is impractical for control modules to simply choose any link (e.g., randomly or in Round Robin fashion), as some choices are clearly better suited for a given operation than others.

### SUMMARY

This Summary is provided to introduce a selection of concepts in a simplified form that are further described herein in the Detailed Description. This Summary is not intended to identify key features or essential features of the claimed subject matter, nor is it intended to be used to limit the scope of the claimed subject matter.

One aspect may provide a method for implementing a link selection protocol in a replication setup of a storage system. The method includes, sending, by a control module to a selected routing module of a plurality of routing modules, a replication IO request. The IO requirements include an amount of data subject to the replication IO request and a latency requirement subject to the replication IO request. The method also includes comparing, by the selected routing module, the IO requirements to link status information of each of a plurality of links; selecting, by the selected routing module, one of the links assigned to the selected routing module as a function of the IO requirements and the link status information; and executing the replication IO request over the selected one of the links.

Another aspect may provide a system for implementing a link selection protocol in a replication setup. The system includes a memory having computer-executable instructions. The system also includes a processor operated by a storage system. The processor executes the computer-executable instructions. When executed by the processor, the computer-executable instructions cause the processor to perform operations. The operations include sending, by a control module to a selected routing module of a plurality of routing modules, a replication IO request. The IO requirements include an amount of data subject to the replication IO request and a latency requirement subject to the replication IO request. The operations also include comparing, by the selected routing module, the IO requirements to link status information of each of a plurality of links; selecting, by the selected routing module, one of the links assigned to the selected routing module as a function of the IO requirements and the link status information; and executing the replication IO request over the selected one of the links.

Another aspect may provide a computer program product for implementing a link selection protocol in a replication setup. The computer program product is embodied on a non-transitory computer readable medium. The computer program product includes instructions that, when executed by a computer at a storage system, causes the computer to perform operations. The operations include sending, by a control module to a selected routing module of a plurality of routing modules, the replication IO request. The IO requirements include an amount of data subject to the replication IO request and a latency requirement subject to the replication IO request. The operations further include comparing, by the selected routing module, the IO requirements to link status information of each of a plurality of links assigned to the selected routing module; selecting, by the selected routing module, one of the links assigned to the selected routing module as a function of the IO requirements and the link status information; and executing the replication IO request over the selected one of the links.

### BRIEF DESCRIPTION OF THE DRAWING FIGURES

Objects, aspects, features, and advantages of embodiments disclosed herein will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features. For clarity, not every element may be labeled in every figure. The drawings are not necessarily to scale, emphasis instead being placed upon illustrating embodiments, principles, and concepts. The drawings are not meant to limit the scope of the claims included herewith.

FIG. 1 is a block diagram illustrating one example of a content-based storage system configured for implementing a link selection protocol in a replication setup in accordance with an embodiment;

FIG. 2 depicts a block diagram of a content-based storage system for implementing a link selection protocol in a replication setup in accordance with an embodiment;

FIGS. 3A-3B are flow diagrams illustrating a process for implementing a link selection protocol in a replication setup in accordance with an embodiment; and

FIG. 4 is a block diagram of an illustrative computer that can perform at least a portion of the processing described herein.

### DETAILED DESCRIPTION

Before describing embodiments of the concepts, structures, and techniques sought to he protected herein, some terms are explained. The following description includes a number of terms for which the definitions are generally known in the art. However, the following glossary definitions are provided to clarify the subsequent description and may be helpful in understanding the specification and claims.

As used herein, the term “storage system” is intended to be broadly construed so as to encompass, for example, private or public cloud computing systems for storing data as well as systems for storing data comprising virtual infrastructure and those not comprising virtual infrastructure. As used herein, the terms “client,” “host,” and “user” refer, interchangeably, to any person, system, or other entity that uses a storage system to read/write data, as well as issue requests for configuration of storage units in the storage system. In some embodiments, the term “storage device” may also refer to a storage array including multiple storage devices. In certain embodiments, a storage medium may refer to one or more storage mediums such as a hard drive, a combination of hard drives, flash storage, combinations of flash storage, combinations of hard drives, flash, and other storage devices, and other types and combinations of computer readable storage mediums including those yet to be conceived. A storage medium may also refer both physical and logical storage mediums and may include multiple level of virtual to physical mappings and may be or include an image or disk image. A storage medium may be computer-readable, and may also be referred to herein as a computer-readable program medium. Also, a storage unit may refer to any unit of storage including those described above with respect to the storage devices, as well as including storage volumes, logical drives, containers, or any unit of storage exposed to a client or application. A storage volume may be a logical unit of storage that is independently identifiable and addressable by a storage system,

In certain embodiments, the term “IO request” or simply “IO” may be used to refer to an input or output request, such as a data read or data write request or a request to configure and/or update a storage unit feature. A feature may refer to any service configurable for the storage system.

In certain embodiments, a storage device may refer to any non-volatile memory (NVM) device, including hard disk drives (HDDs), solid state drivers (SSDs), flash devices (e.g., NAND flash devices), and similar devices that may be accessed locally and/or remotely (e.g., via a storage attached network (SAN) (also referred to herein as storage array network (SAN)).

In certain embodiments, a storage array (sometimes referred to as a disk array) may refer to a data storage system that is used for block-based, file-based or object storage, where storage arrays can include, for example, dedicated storage hardware that contains spinning hard disk drives (HDDs), solid-state disk drives, and/or all-flash drives. Flash, as is understood, is a solid-state (SS) random access media type that can read any address range with no latency penalty, in comparison to a hard disk drive (HDD) which has physical moving components which require relocation when reading from different address ranges and thus significantly increasing the latency for random IO data. An exemplary content addressable storage (CAS) array is described in commonly assigned U.S. Pat. No. 9,208,162 (hereinafter “'162 patent”), which is hereby incorporated by reference).

In certain embodiments, a data storage entity may be any one or more of a file system, object storage, a virtualized device, a logical unit, a logical unit number, a logical volume, a logical device, a physical device, and/or a storage medium.

In certain embodiments, a logical unit (LU) may be a logical entity provided by a storage system for accessing data from the storage system, and as used herein a logical unit is used interchangeably with a logical volume. In many embodiments herein, a LU or LUN (logical unit number) may be used interchangeable for each other. In certain embodiments, a LUN may be a logical unit number for identifying a logical unit; may also refer to one or more virtual disks or virtual LUNs, which may correspond to one or more Virtual Machines.

While vendor-specific terminology may be used herein to facilitate understanding, it is understood that the concepts, techniques, and structures sought to be protected herein are not limited to use with any specific commercial products. In addition, to ensure clarity in the disclosure, well-understood methods, procedures, circuits, components, and products are not described in detail herein.

The phrases, “such as,” “for example,” “e g.,” “exemplary,” and variants thereof, are used herein to describe non-limiting embodiments and are used herein to mean “serving as an example, instance, or illustration.” Any embodiments herein described via these phrases and/or variants are not necessarily to be construed as preferred or advantageous over other embodiments and/or to exclude the incorporation of features from other embodiments. In addition, the word “optionally” is used herein to mean that a feature or process, etc., is provided in some embodiments and not provided in other embodiments.” Any particular embodiment of the invention may include a plurality of “optional” features unless such features conflict.

As described above, the embodiments described herein provide a technique for implementing a link selection protocol in a replication setup. In a storage system that implements data replication, there are typically many links through which replication requests can be processed. Each of these links may experience frequent changes in throughput and latency due to conditions, such as different media use used for the link, the amount of work already sent to the link, link issues, or load on the target. With the vast number of operations performed over a replication cycle, there is typically a delay in the time it takes to update the control modules with information about the state of the links. As a result, control modules may be unable to make an informed decision on which links to choose for incoming replication requests. On the other hand, the routing modules, which have direct access to their assigned links and working queues, have the most up-to-date information concerning the state of their links.

The embodiments enable a routing module to use up-to-date link status information for each of the links assigned thereto to determine the most suitable link for any given replication IO operation. The embodiments include a two-step process: routing modules send aggregated link status information to control modules, which in turn use the aggregated link status information to select one of the routing modules to process a replication IO request; and the selected routing module, in turn, uses its individual link status information to determine the most suitable link for processing the replication IO request.

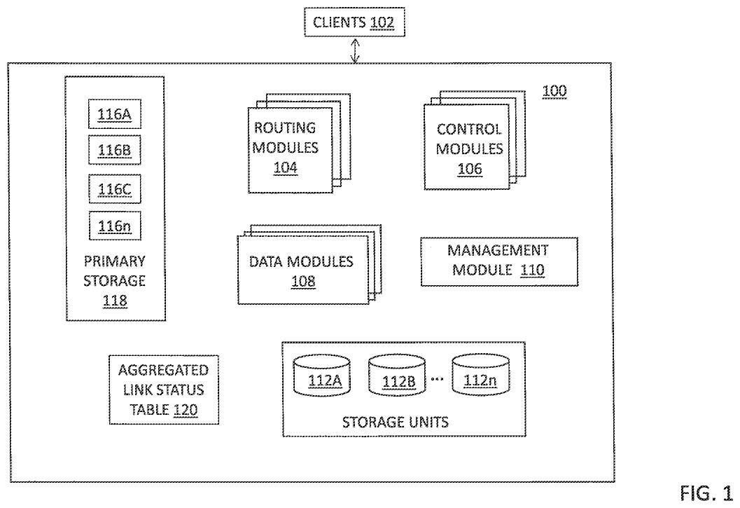

Turning now to FIG. 1, a content-addressable storage system for implementing a link selection protocol in a replication setup will now be described. In an embodiment, the content-addressable storage system may be implemented using a storage architecture, such as XtremIO by EMC DELL of Hopkinton, Mass. For purposes of illustration, the system 100 is described herein as performing replication sessions in any type and/or combination of replication modes (e.g., synchronous, asynchronous, active/active).

The storage system 100 may include a plurality of modules 104, 106, 108, and 110, a plurality of storage units 112A-112n, which may be implemented as a storage array, and a primary storage 118. In some embodiments, the storage units 112A-112n may be provided as, e.g., storage volumes, logical drives, containers, or any units of storage that are exposed to a client or application (e.g., one of clients 102).

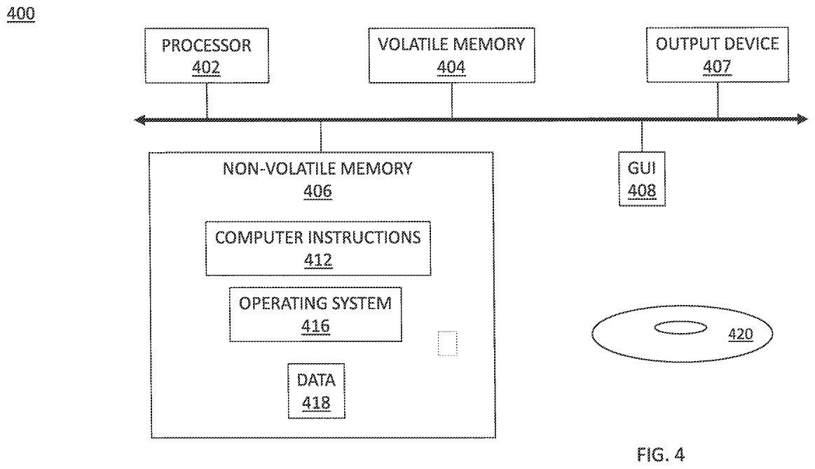

In one embodiment, modules 104, 106, 108, and 110 may be provided as software components, e.g., computer program code that, when executed on a processor, may cause a computer to perform functionality described herein. In a certain embodiment, the storage system 100 includes an operating system (OS) (shown generally in FIG. 4), and the one or more of the modules 104, 106, 108, and 110 may be provided as user space processes executable by the OS.

In other embodiments, one or more of the modules 104, 106, 108, and 110 may be provided, at least in part, as hardware, such as digital signal processor (DSP) or an application specific integrated circuit (ASIC) configured to perform functionality described herein. It is understood that the modules 104, 106, 108, and 110 may be implemented as a combination of software components and hardware components. Any number of routing, control, and data modules 104, 106, and 108, respectively, may be implemented in the system 100 in order to realize the advantages of the embodiments described herein.

The routing modules 104 may be configured to terminate storage and retrieval operations and distribute commands to the control modules 106 that may be selected for operations in such a way as to retain balanced usage within the system. The control modules 106 may be communicatively coupled to one or more routing modules 104 and the routing modules 104, in turn, may be communicatively coupled to one or more storage units 112A-112n.

In embodiments, the control modules 106 select an appropriate routing module 104 to send a replication IO request from a client 102. The routing module 104 receiving the replication IO request sends the IO request to a data module 108 for execution and returns results to the control module 106. The requests may be sent using SCSI or similar means.

The control module 106 may control execution of read and write commands to the storage units 112A-112n through the routing modules 104. The data modules 108 may be connected to the storage units 112A-112n and, under control of the respective control module 106, may pass data to and/or from the storage units 112A-112n via suitable storage drivers (not shown).

Data module 108 may be communicatively coupled to corresponding control modules 106, routing modules 104, and the management module 110. In embodiments, the data module 108 is configured to perform the actual read/write (R/W) operations by accessing the storage units 112A-112n attached to them.

As indicated above, the data module 108 performs read/write operations with respect to one or more storage units 112A-112n. In embodiments, the storage system 100 performs replication sessions in synchronous, asynchronous, or metro replication mode in which one or more of the storage units 112A-112n may be considered source devices and others of the storage units 112A-112n may be considered target devices to which data is replicated from the source devices. The storage system 100 may be configured to perform native replication.

The management module 110 may be configured to monitor and track the status of various hardware and software resources within the storage system 100. In some embodiments, the management module 110 may manage the allocation of memory by other modules (e.g., routing modules 104, control modules 106, and data modules 108.

The primary memory 118 can be any type of memory having access times that are faster compared to the storage units 112A-112n. In some embodiments, primary memory 118 may be provided as dynamic random-access memory (DRAM). In certain embodiments, primary memory 118 may be provided as synchronous DRAM (SDRAM). In one embodiment, primary memory 118 may be provided as double data rate SDRAM (DDR SDRAM), such as DDR3 SDRAM. These differing types of memory are shown generally in FIG. 1 as 116A-116n.

In some examples, the system 100 may employ more than a single type of memory technology, including a mix of more than one Flash technology (e,g., single level cell (SLC) flash and multilevel cell (MLC) flash), and a mix of Flash and DRAM technologies. In certain embodiments, data mapping may optimize performance and life span by taking advantage of the different access speeds and different write/erase cycle limitations of the various memory technologies.

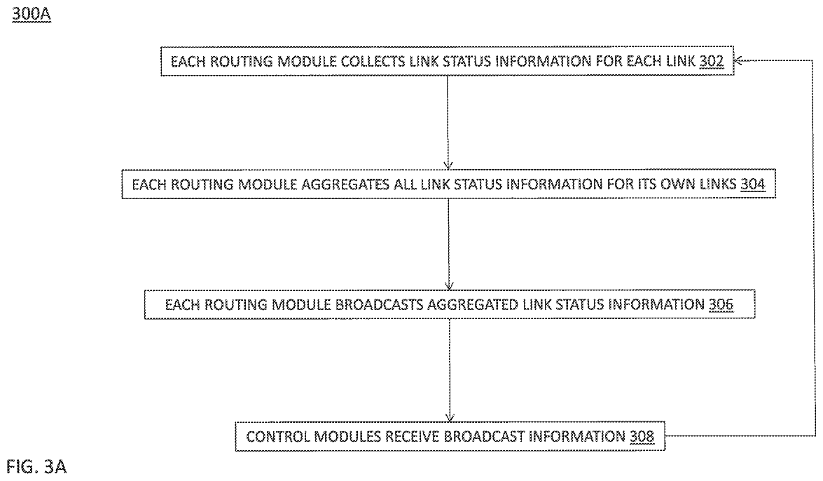

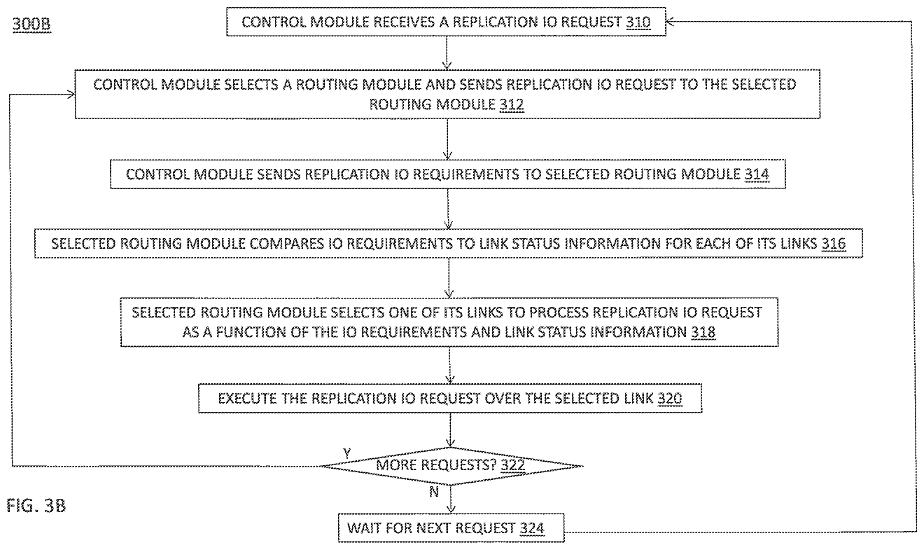

Also shown in the system 100 of FIG. 1 is an aggregated link status information table 120 that is used by the link selection protocol process to enable control modules to identify which routing modules are most suitable to send incoming replication IO requests. The table 120 may be populated by each of the routing modules in the system based on their collective link statuses. The table 120 is updated frequently, e.g., every few seconds. This table is further described with respect to FIGS. 3A-3B.

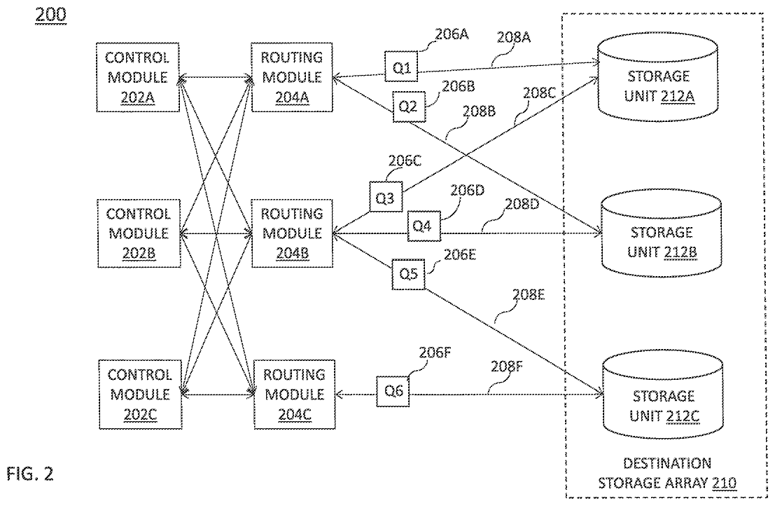

Turning now to FIG. 2, a system 200 for implementing a link selection protocol in a replication setup will now be described. The system 200 incorporates many of the elements of FIG. 1 and further illustrates various links and queues used by the system.

As shown in FIG. 2, the system includes control modules 202A-202C, each of which is communicatively coupled to corresponding routing modules 204A-204C. While only three routing and control modules are shown in FIG. 2, it will be understood that any number of control and routing modules may be implemented in order to realize the advantages of the embodiments described herein. In addition, while each routing module is shown as having a corresponding replication link, it will be understood that not all routing modules need to have replication links (e.g., a routing module that is not designated or configured for replication operations).

Also shown in FIG. 2 are links 208A-208F, which communicatively connect each of the routing modules 204A-204C to respective storage units 212A-212C. Each of the links may be implemented as serial data cables or wires. In other embodiments, the links may be implemented over a wireless network. Each of the links has a corresponding queue (queues 206A-206F, also referred as Q1-Q6, respectively) that temporarily holds replication IO requests received from a client. The replication IO requests are temporarily held if other earlier requests are in process of execution or are received in the queue after to any earlier received requests that are pending in the queue.

The storage units 212A-212C are storage units of a destination storage array 210 in which data from a source device is replicated to the destination storage array 210. In one embodiment, the destination storage array may be identical to the source storage array; however, this is not required. In an alternative embodiment, for example, the destination storage array may be different than the source storage array (e.g., the destination storage array may have a different architecture or may be manufactured by a different vendor).

Turning now to FIGS. 3A-3B, flow diagrams 300A-300B for implementing a link selection protocol in a replication setup for an active replication session will now be described in accordance with an embodiment. The process 300A of FIG. 3A provides a description of a technique for acquiring and processing link status information for a storage system, and the process 300B of FIG. 3B provides a description of a technique for using the link status information to process replication IO requests.

In block 302 of FIG. 3A, during an active replication session, each of the routing modules collect link status information from a queue corresponding to each of its assigned links. The routing modules may collect this information through observing recently executed IO operations and determining a time of completion of the IO operations and an amount of data associated with the IO operations. In addition the information acquired may include information obtained from the lower-level protocol layer. For example, a TCP kernel process may report queue size, bit error rates, and other information. This information enables the routing modules to understand any current bandwidth or capacity constraints associated with the links. In embodiments, the link information collected includes an estimated latency and estimated bandwidth (capacity).

In block 304, each of the routing modules aggregates the link status information for collective assigned links, and periodically broadcasts (e.g., every few seconds) the aggregated link status information in block 306. In one embodiment, the aggregated link status information may be sent to the control modules in the storage system that are assigned to the routing modules. In another embodiment, the aggregated link status information may be sent to a centralized system manager module (e.g., management module 110 of FIG. 1). In this embodiment, the system manager module, in turn, forwards the aggregated link status information to each of the control modules. In a further embodiment, the aggregated link status information may be stored in a table (e.g., table 120 of FIG. 1) and accessed by one of the management module or directly by the control modules to determine the current collective link statuses of the routing modules.

In block 308, the control modules receive the broadcast information. The process 300A of FIG. 3A may be performed in a loop fashion, e.g., every few seconds to update the current state of the links to the system.

As indicated above, the process 300B of FIG. 3B describes a technique for processing replication IO requests using the link status information broadcast in FIG. 3A. In block 310, a replication IO request is received by a control module. In response to a replication IO request, the routing modules may return the current link status information. This enables the control modules to see the most up-to-date information for the routing modules.

The control module selects one of the routing modules to send a replication IO request and sends the request to the selected routing module in block 312. The routing module is selected to process the replication IO request as a function of the aggregated link status information and the IO requirements of the replication IO request. For example, if the IO requirements indicates that the IO request will need low latency and high bandwidth, the control module looks at the aggregated link status information of the routing modules to determine which of them has a current aggregated link status that will best serve this replication IO request. The control module does not see the individual link information status for each routing module.

In block 314, the control module sends the IO requirements for the request to the selected routing module. The IO requirements may include an amount of data subject to the request, as well as a latency requirement for the request.

In block 316, the routing module compares the IO requirements to the individual link status information for each of the links assigned thereto. In block 318, the routing module selects one of the links that is moat suitable to handle processing of the replication IO request. The link is selected as a function of the IO requirements and the link status information for that link. For example, suppose the replication IO request is an asynchronous request, where latency is not important. The routing module may select a link having high latency and high capacity and to reserve a lower capacity/latency link in case a synchronous replication IO request comes in, which is latency sensitive. Thus, when a replication IO request comes in for a synchronous request, the routing module may select a link with low latency.

In block 320, the replication IO request is then executed over the selected link for execution. In block 322, it is determined whether another replication IO request has been received. If so, the process 3003 returns to block 312. Otherwise, if no request is pending, the system waits for the next incoming request in block 324. The process 300B of FIG. 3B can be repeated in a loop fashion for each replication IO request through the replication session.

FIG. 4 shows an exemplary computer 400 (e.g., physical or virtual) that can perform at least part of the processing described herein. The computer 400 includes a processor 402, a volatile memory 404, a non-volatile memory 406 (e.g, hard disk or flash), an output device 407 and a graphical user interface (GUI) 408 (e.g., a mouse, a keyboard, a display, for example). The non-volatile memory 406 stores computer instructions 412, an operating system 416 and data 418. In one example, the computer instructions 412 are executed by the processor 402 out of volatile memory 404. In one embodiment, an article 420 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e,g., an FPGA (field programmable gate array) and/or an ASIC (application-specific integrated circuit)).

Having described exemplary embodiments of the invention, it will now become apparent to one of ordinary skill in the art that other embodiments incorporating their concepts may also be used. The embodiments contained herein should not be limited to the disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

1. A method for implementing a link selection protocol in a replication setup of a storage system, the method comprising:
receiving, by a control module, aggregated link status information from a plurality of routing modules, each of the routing modules managing a corresponding plurality of links to storage devices of the storage system and providing collected link status information for its corresponding plurality of links;
selecting, by the control module, a routing module of the plurality of routing modules to process a replication input/output (IO) request based on the aggregated link status information, the control module having no individual link status information for the links managed by the plurality of routing modules;
sending, by the control module to the selected routing module, the replication IO request and IO requirements to process the replication IO request, the IO requirements including an amount of data subject to the replication IO request and a latency requirement subject to the replication IO request;
comparing, by the selected routing module, the IO requirements to updated link status information for the plurality of links managed by the selected routing module;
selecting, by the selected routing module, one of the links of the plurality of links as a function of the IO requirements and the updated link status information; and
executing the replication IO request over the selected one of the links;
wherein each of the plurality of routing modules implements:
collecting link status information for its corresponding plurality of links, the link status information for each link of the plurality of links being collected from a queue corresponding to each link of the plurality of links;
aggregating the collected link status information for the plurality of links; and
periodically broadcasting the aggregated link status information.

2. (canceled)

3. The method of claim 1, wherein collecting the link status information includes observing recently executed IO operations and determining a time to complete the IO operations and an amount of data associated with the IO operations.

4. The method of claim 1, wherein broadcasting the aggregated link status information includes one of:
sending the aggregated link status information to a plurality of control modules assigned to the plurality of routing modules, the plurality of control modules including the control module; and
sending the aggregated link status information to a centralized system manager module, the system manager module forwarding the aggregated link status information to each of the plurality of control modules.

5. The method of claim 1, wherein the control module selects the routing module to process the replication IO request as a function of the aggregated link status information and the IO requirements.

6. The method of claim 1, wherein selecting by the routing module one of the links comprises selecting a link with low latency and low capacity when the replication IO request is a synchronous IO request.

7. The method of claim 1, wherein selecting by the routing module one of the links comprises selecting a link with high latency and high capacity when the replication IO request is an asynchronous IO request.

8. A system for implementing a link selection protocol in a replication setup of a storage system, the system comprising:
a memory comprising computer-executable instructions; and
a processor operable by a storage system, the processor executing the computer-executable instructions, the computer-executable instructions when executed by the processor cause the processor to perform operations comprising:
receiving, by a control module, aggregated link status information from a plurality of routing modules, each of the routing modules managing a corresponding plurality of links to storage devices of the storage system and providing collected link status information for its corresponding plurality of links;
selecting, by the control module, a routing module of the plurality of routing modules to process a replication input/output (IO) request based on the aggregated link status information, the control module having no individual link status information for the links managed by the plurality of routing modules;
sending, by the control module to the selected routing module, the replication IO request and IO requirements including an amount of data subject to the replication IO request and a latency requirement subject to the replication IO request ;
comparing, by the selected routing module, the IO requirements to updated link status information for the plurality of links managed by the selected routing module;
selecting, by the selected routing module, one of the links of the plurality of links as a function of the IO requirements and the updated link status information; and
executing the replication IO request over the selected one of the links;
wherein each of the plurality of routing modules implements:
collecting link status information for its corresponding plurality of links, the link status information for each link of the plurality of links being collected from a queue corresponding to each link of the plurality of links;
aggregating the collected link status information for the plurality of links; and
periodically broadcasting the aggregated link status information.

9. (canceled)

10. The system of claim 8, wherein collecting the link status information includes observing recently executed IO operations and determining a time to complete the IO operations and an amount of data associated with the IO operations.

11. The system of claim 8, wherein broadcasting the aggregated link status information includes one of:
sending the aggregated link status information to a plurality of control modules assigned to the plurality of routing modules, the plurality of control modules including the control module; and
sending the aggregated link status information to a centralized system manager module, the system manager module forwarding the aggregated link status information to each of the plurality of control modules.

12. The system of claim 8, wherein the control module selects the routing module to process the replication IO request as a function of the aggregated link status information and the IO requirements.

13. The system of claim 8, wherein selecting, by the routing module, one of the links comprises selecting a link with low latency and low capacity when the replication IO request is a synchronous IO request.

14. The system of claim 8, wherein selecting by the routing module, one of the links comprises selecting a link with high latency and high capacity when the replication IO request is an asynchronous IO request.

15. A computer program product for implementing a link selection protocol in a replication setup of a storage system, the computer program product embodied on a non-transitory computer readable medium, the computer program product including instructions that, when executed by a computer, causes the computer to perform operations comprising:
receiving, by a control module, aggregated link status information from a plurality of routing modules, each of the routing modules managing a corresponding plurality of links to storage devices of the storage system and providing collected link status information for its corresponding plurality of links;
selecting, by the control module, a routing module of the plurality of routing modules to process a replication input/output (IO) request based on the aggregated link status information, the control module having no individual link status information for the links managed by the plurality of routing modules;
sending, by the control module to the selected routing module, the replication IO request and IO requirements to process the replication IO request, the IO requirements including an amount of data subject to the replication IO request and a latency requirement subject to the replication IO request;
comparing, by the selected routing module, the IO requirements to updated link status information for the plurality links managed by the selected routing module;
selecting, by the selected routing module, one of the links of the plurality of links as a function of the IO requirements and the updated link status information; and
executing the replication IO request over the selected one of the links;
wherein each of the plurality of routing modules implements:
collecting link status information for its corresponding plurality of links, the link status information for each link of the plurality of links being collected from a queue corresponding to each link of the plurality of links;
aggregating the collected link status information for the plurality of links; and
periodically broadcasting the aggregated link status information.

16. (canceled)

17. The computer program product of claim 15, wherein collecting the link status information includes observing recently executed IO operations and determining a time to complete the IO operations and an amount of data associated with the IO operations.

18. The computer program product of claim 15, wherein broadcasting the aggregated link status information includes one of:
sending the aggregated link status information to a plurality of control modules assigned to the plurality of routing modules, the plurality of control modules including the control module; and
sending the aggregated link status information to a centralized system manager module, the system manager module forwarding the aggregated link status information to each of the plurality of control modules.

19. The computer program product of claim 15, wherein the control module selects the routing module to process the replication IO request as a function of the aggregated link status information and the IO requirements.

20. The computer program product of claim 15, wherein selecting, by the routing module, one of the links comprises:
selecting a link with low latency and low capacity when the replication IO request is a synchronous IO request; and
selecting a link with high latency and high capacity when the replication IO request is an asynchronous IO request.
